(19) United States
(12) Patent Application Publication
(10) Pub. No.: US 2022/0245676 A1
(43) Pub. Date: Aug. 4, 2022

(54) METHOD FOR GENERATING PERSONALIZED PRODUCT DESCRIPTION BASED ON MULTI-SOURCE CROWD DATA

(71) Applicant: Northwestern Polytechnical University, Xi'an (CN)

(72) Inventors: Bin Guo, Xi'an (CN); Qiuyun Zhang, Xi'an (CN); Zhiwen Yu, Xi'an (CN); Zhu Wang, Xi'an (CN); Jiaqi Liu, Xi'an (CN); Shaoyang Hao, Xi'an (CN)

(21) Appl. No.: 17/725,494

(22) Filed: Apr. 20, 2022

Related U.S. Application Data
(63) Continuation of application No. PCT/CN2020/117263, filed on Sep. 24, 2020.

(30) Foreign Application Priority Data
Oct. 24, 2019 (CN) 201911015944.5

(51) Int. Cl. G06Q 30/02; G06Q 30/06

(52) U.S. Cl. CPC G06Q 30/0271; G06Q 30/0631

(57) ABSTRACT

This disclosure provides a method for generating a personalized product description based on multi-source crowd data, which includes following steps: collecting data required for the personalized product description, the required data including reviews for crowd products and historical reviews of a crowd of users; portraiting the product and user to obtain a user preference label and a product label, which are then matched to obtain a personalized preference label; and generating the personalized product description in conjunction with the personalized preference labels. For different product attributes, different text generation methods are employed, and with different characteristics of the text generation methods such as extracted text generation and generated text generation, multi-source data are fused, so that the generated product description is smoother.

### CROSS-REFERENCE TO RELATED APPLICATION(S)

This application claims priority to and the benefit of Chinese Patent Application Serial No. 201911015944.5, filed Oct. 24, 2019, the entire disclosure of which is hereby incorporated by reference.

### TECHNICAL FIELD

This disclosure relates to a field of deep learning, in particular to a method for generating a personalized product description based on multi-source crowd data.

### BACKGROUND

In recent years, with rapid development of e-commerce, more and more people choose to shop online, and product description is particularly important for purchase choices of customers in absence of accessing physical products. Traditional product description methods recommend the products themselves and push a same product content to different users, but the different users pay different attention to the same product, so that a same product description may not effectively attract the users. Good product descriptions not only increase a click rate from the users, but also help the users to make a choice. In recent years, generation of a personalized product description has been widely concerned by researchers, in which preferences of the users on the products may be obtained by portraiting of the users, based on which the personalized product description may be generated. On one hand, the personalized product description may provide product information needed by the users more accurately and stimulate purchase interests of the users; and on the other hand, it may reduce cost of writing the product description manually.

Traditional text generation methods take a pipelined mode, in which text is processed semantically, grammatically and on sentence respectively, then “what to say” and “how to say” are determined successively, which may not meet requirements of generating texts for requested scenarios and matched subjects.

### SUMMARY

In view of above problems, the present disclosure proposes a method for generating a personalized product description based on multi-source crowd data.

The method for generating the personalized product description based on multi-source crowd data includes following steps S1 to S3.

step S1: collecting data required for personalized product description, the required data including users and product data respectively used to portrait a user and a product, and reviews for the product used to generate the personalized product description;

step S2: portraiting the product, product attributes most concerned by the user being extracted from the reviews for the product so as to obtain a selling label and corresponding attributes;

step S3: portraiting the user to obtain a user label from historical reviews, and then to obtain a personalized preference label matched with the product portraiting; and

step S4: combining the reviews for the product in step S1 to generate a corresponding personalized product description employing different text generation methods for different preference labels with a codec structure.

Further, in the method, the portraiting of the user in step S3 employs a quantitative portraiting method, and the historical reviews of the user are statistically analyzed to obtain the user preference label.

Further, in the method, it further includes a redundancy text preprocessing of the reviews for the product in step S4, in which redundant reviews with high similarity are deleted and only representative reviews are reserved for each type of the reviews.

Further, in the method, the redundancy text preprocessing specifically includes segmenting the text into words, listing a set of the words corresponding to the sentences (without repeating), calculating a word frequency to obtain word frequency vectors, and then calculating a cosine similarity between word frequency vectors of the sentences according to equation (1)

$$cos ( θ ) = \frac{{\sum }_{i = 1}^{n} ( {x}_{i} * {y}_{i} )}{\sqrt{{\sum }_{i = 1}^{n} {( {x}_{i} )}^{2}} * \sqrt{{\sum }_{i = 1}^{n} {( {y}_{i} )}^{2}}}$$

and removing the word frequency vectors with similarity greater than 0.8 as redundant data.

Further, in the method, the personalized product description generation in step S4 also includes word embedding, in which a segmentation operation for words is performed first to divide the sentence into word sequences, segmented data is then word embedded with a Word2vec tool, so as to obtain a vector representation of each word in a sentence sequence.

Further, in the method, the personalized product description generation method in step S4 includes a personalized product description generation model containing text generation modules, in which final personalized product recommendation text, namely the product personalized description, is spliced with product recommendation texts obtained with the text generation modules.

Further, in the method, the personalized product description generation model includes three text generation modules, an Encoder-Decoder generation product description text module, a template generation advertisement recommendation text module and an extracted generation advertisement recommendation text module.

Further, in the method, the Encoder-Decoder generation product description text module employs a Senquence to Sequence architecture. The template generation advertisement recommendation text module uses a template-rule generation method, in which a structure of the template, a value range of each variable in the template, and a calling rule of the template need to be defined, and according to the input, the template is called and filled to generate a generated sentence; and the extracted generation advertisement recommendation text module extracts important information in the text with a textrank extraction method, and synthesizes a corpus of related authors with the textrank, and author-related information obtained from a database with the author name is inputted and an advertisement recommendation text corresponding to keywords about the author is outputted.

Further, in the method, the Encoder-Decoder generation product description text module introduces an Attention mechanism, so that the model may focus on input information that is more important to current target words at every moment of a decoding stage.

Further, in the method, a double-layer template of sentence and phrase are provided in the template-rule generation method, a sentence template is used between sentences, and a phrase template is used within a sentence.

The disclosure has following benefits: a method for generating the personalized product description is provided based on multi-source crowd data, in which with a word vector model, text content may be represented in a vector form that may be calculated by a machine. Input user portrait and product portrait are matched and then coded with a codec structure, in which a resulting coded vector is decoded to generate a personalized product recommendation text in a word-wise manner. For different product attributes, different text generation methods are employed, and with different characteristics of the text generation methods such as extracted text generation and generated text generation, multi-source data are fused, so that the generated product description is smoother.

### BRIEF DESCRIPTION OF THE DRAWINGS

FIG. 1 is a flow chart of an embodiment of a method for generating a personalized product description based on multi-source crowd data; and

FIG. 2 is a block diagram of generating a text in the method for generating the personalized product description based on multi-source crowd data.

### DETAILED DESCRIPTION

Technical schemes of the present disclosure will be described with reference to the figures in the following. The method for generating the personalized product description based on multi-source crowd data includes following steps S1 to S4.

In step S1, data required for personalized product description is collected. The required data includes users and product data respectively used to portrait a user and a product, and reviews for the product used to generate the personalized product description.

In step S2, the product is portraited, and product attributes most concerned by the user are extracted from the reviews for the product so as to obtain a selling label and corresponding attributes.

In step S3, the user is portraited to obtain a user label from historical reviews, and then to obtain a personalized preference label matched with the product portraiting.

In the step S4, the reviews for the product in step S1 are combined to generate a corresponding personalized product description employing different text generation methods for different preference labels with a codec structure.

It further includes a redundancy text preprocessing of the reviews for the product in step S4, in which redundant reviews with high similarity are deleted and only representative reviews are reserved for each type of the reviews.

The redundancy text for the reviews for the product in step S1 is preprocessed, since the reviews for the product in a trading platform usually contain a lot of redundant information due to repeated contents. The text is segmented into words, a set of the words corresponding to the sentences (without repeating) are listed, a word frequency is calculated to obtain word frequency vectors, and then a cosine similarity between word frequency vectors of the sentences is calculated according to equation (1), and those with similarity greater than 0.8 is punished and removed as redundant data. The cosine similarity is a similarity calculated from cosine of angles between two vectors. By calculating the cosine similarity between different reviews in a same type in a review dataset, redundant reviews with high similarity are deleted, only representative reviews are reserved for each type of the reviews.

$$cos ( θ ) = \frac{{\sum }_{i = 1}^{n} ( {x}_{i} * {y}_{i} )}{\sqrt{{\sum }_{i = 1}^{n} {( {x}_{i} )}^{2}} * \sqrt{{\sum }_{i = 1}^{n} {( {y}_{i} )}^{2}}} \qquad ( 1 )$$

The personalized product description generation in step S4 also includes word embedding, in which a segmentation operation for words is performed first to divide the sentence into word sequences, segmented data is then word embedded with a Word2vec tool, so as to obtain a vector representation of each word in a sentence sequence. Representing a word as a vector is called word embedding. The word w is represented as a vector C(w) with a fixed length m, where m is a length of the word vector. In this way, the whole thesaurus may be represented as a matrix of m×|V|, where each column is a word vector and |V| is the number of words in the thesaurus. The input for word embedding is a set of non-repeating words in an original text, and the output is a vector corresponding to each word. There is no natural space separator between words in chinese sentences, so that word segmentation is needed before the processing of word embedding. After the chinese text is segmented, the sentence is divided into word sequences. Segmented data is then word embedded with a Word2vec tool, so as to obtain a vector representation of each word in a sentence sequence.

The personalized product description generation method in step S4 includes a personalized product description generation model containing text generation modules, in which final personalized product recommendation text, namely the product personalized description, is spliced with product recommendation texts obtained with the text generation modules.

The personalized product description generation model includes three text generation modules, an Encoder-Decoder generation product description text module, a template generation advertisement recommendation text module and an extracted generation advertisement recommendation text module.

The Encoder-Decoder generation product description text module employs a Senquence to Sequence architecture that is implemented with a codec structure herein. An encoder transforms a source sequence into an intermediate semantic vector with a fixed length, and a decoder transforms the intermediate semantic vector into a target sequence. In the Encoder-Decoder architecture, the encoder is equivalent to information compression, while the decoder is equivalent to information restoration. Generally, the encoder uses a RNN or LSTM neural network to integrate and compress information of the text sequences to obtain semantic vectors. At a moment t, a state of a hidden layer of the RNN neural network may be represented as formula 2:

$${h}^{( t )} = ϕ ( {Ux}^{( t )} + {Wh}^{( t - 1 )} + b ) \qquad ( 2 )$$

indicates an input at the moment t, indicates a state of the hidden layer at last moment. It may be seen from formula 1 that the state of the hidden layer at the moment t is determined not only by a current input, but also by the state of the hidden layer at last moment. This cycling structure makes the RNN neural network suitable for processing the sequences. For the encoder consisting of m RNN units, an intermediate semantic vector c is obtained for the state of the hidden layer with three methods corresponding to formula 3, 4 and 5:

$$\begin{matrix}c = {h}_{m} & ( 3 ) \\ c = q ( {h}_{m} ) & ( 4 ) \\ c = q ( {h}_{1} , {h}_{2} , … , {h}_{m} ) & ( 5 )\end{matrix}$$

Then with formula 5, another RNN or LSTM network is used for decoding to obtain the target sequence. In the decoding stage, the state of the hidden layer at the moment t is determined together by the state of the hidden layer at a moment t−1, an output at the moment t−1 and the intermediate semantic vector c output by the encoder. As illustrated with formula 6:

$${s}_{t} = f ( {s}_{t - 1} , {y}_{t - 1} , c ) \qquad ( 6 )$$

In this module, an attention mechanism is introduced to enhance results of text generation. The calculation method is shown in formula 7, 8, 9 and 10:

$$\begin{matrix}{c}_{i} = {\sum }_{j = 1}^{{T}_{x}} {α}_{ij} {h}_{j} & ( 7 ) \\ {α}_{ij} = \frac{exp ( {e}_{ij} )}{{\sum }_{k = 1}^{{T}_{x}} {e}_{ik}} & ( 8 ) \\ {e}_{ij} = α ( {s}_{i - 1} , {h}_{j} ) & ( 9 ) \\ {e}_{ij} = {h}_{t}^{T} {\overline{h}}_{s} & ( 10 )\end{matrix}$$

The model added with the Attention mechanism breaks limitation that only the hidden vector with a fixed length may be used at a final moment of the encoding stage, so that the decoder can use the encoding vector of the encoder at each moment to learn content at each moment related to the current decoding moment, thus the model is greatly improved.

The template generation advertisement recommendation text module uses a template-rule generation method, in which a structure of the template, a value range of each variable in the template, and a calling rule of the template need to be defined. When the system operates, the template is called and filled to generate a generated sentence according to the input. The template-based method has certain flexibility and high portability among different task fields. A double-layer template of sentence and phrase are provided in the template-rule generation method, a sentence template is used between sentences, and a phrase template is used within a sentence.

The extracted generation advertisement recommendation text module extracts important information in the text with a textrank extraction method, and synthesizes a corpus of related authors with the textrank, and author-related information obtained from a database with the author name is inputted and an advertisement recommendation text corresponding to keywords about the author is outputted.

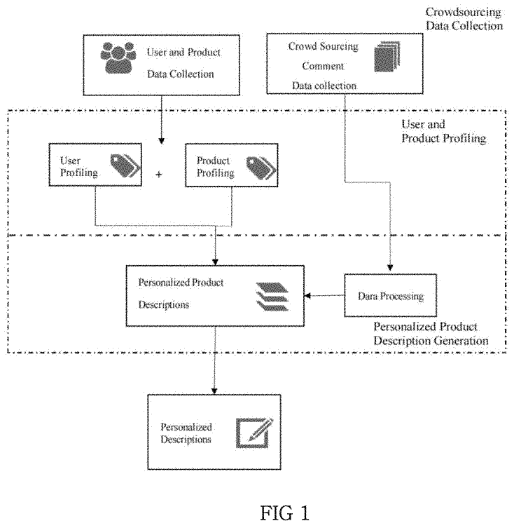

In an embodiment, as shown in FIG. 1, in step S1, collecting two datasets required for the personalized product description: 1) historical reviews of the users used to portrait the users; 2) review contents of the products used to portrait the products and generate the personalized product description. Product trading websites and product community discussion websites pay attention to different aspects of the products. The trading platforms focus on appearance, logistics and other attributes of the products, and the product community discussion websites focus on quality and usage of the products. Therefore, using multi-source datasets may take more aspects and attributes of the product into account.

In step S2, the product is portraited and product attributes most concerned by the user are extracted from the reviews for the products. Taking portraits of books as an example, the portraiting is realized according to acquired book information. Information such as author, binding form and press of the books may be obtained from a book trading website, and information about content of the books may be obtained from a book content discussion website, both information may be used together as a book label for portraiting. Finally, a set of aspects Book_{Aspect} of the book portrait is determined as:

Book_{Aspect}={author,binding form,book subject,press}

In step S3: the user is portraited to obtain a respective user label. Taking the user portrait of the books as an example:

user_{preference}={author,binding form,book subject,press}

In this step, the portraiting of the users in S3 employs a quantitative portraiting method, and the historical reviews of the user are statistically analyzed to obtain the user preference label. The acquired book data is analyzed to obtain description labels of the books.

Taking the books as an example, rules for the user portraiting is shown Table 1.

| User Label | Statistical Rule |
|---|---|
| Author | In frequency statistics of the author, top |
| | two authors are taken as favorites of the user |
| Binding Form | If hardcover books account for more than 50% |
| | of the favorite books, the binding preference |
| | of the user is hardcover |
| Book Subject | In frequency statistics of subject labels, |
| | top five subjects are taken as favorites |
| | of the users |
| Press | In frequency statistics of the press, top two |
| | presses are taken as favorites of the user. |

In step S4, the redundancy text for the reviews for the product in step S1 is preprocessed, since the reviews for the product in a trading platform usually contain a lot of redundant information due to repeated contents. The text is segmented into words, a set of the words corresponding to the sentences (without repeating) are listed, a word frequency is calculated to obtain word frequency vectors, and then a cosine similarity between word frequency vectors of the sentences is calculated according to equation (11), and those with similarity greater than 0.8 is punished and removed as redundant data. The cosine similarity is a similarity calculated from cosine of angles between two vectors. By calculating the cosine similarity between different reviews in a same type in a review dataset, redundant reviews with high similarity are deleted, only representative reviews are reserved for each type of the reviews.

$$cos ( θ ) = \frac{{\sum }_{i = 1}^{n} ( {x}_{i} * {y}_{i} )}{\sqrt{{\sum }_{i = 1}^{n} {( {x}_{i} )}^{2}} * \sqrt{{\sum }_{i = 1}^{n} {( {y}_{i} )}^{2}}} \qquad ( 11 )$$

In step S5, word embedding is performed, representing a word as a vector is called word embedding. The word w is represented as a vector C(w) with a fixed length m, where m is a length of the word vector. In this way, the whole thesaurus may be represented as a matrix of m×|V|, where each column is a word vector and |V| is the number of words in the thesaurus. The input for word embedding is a set of non-repeating words in an original text, and the output is a vector corresponding to each word. There is no natural space separator between words in chinese sentences, so that word segmentation is needed before the processing of word embedding. After the chinese text is segmented, the sentence is divided into word sequences. Segmented data is then word embedded with a Word2vec tool, so as to obtain a vector representation of each word in a sentence sequence.

In step S6, the personalized product description is generated, the product labels obtained in S2 are matched with the user labels obtained in S3, corresponding personalized product descriptions are generated for different preference labels. A personalized product description generation model utilizes different keywords of the personalized preference labels. This model includes three text generation modules, which generate corresponding description texts respectively with generated, extracted and template-rule generation methods. Finally, corresponding product description texts generated from the different keywords are spliced to obtain a final product description content. Functions of different text generation modules are illustrated with the example of the books.

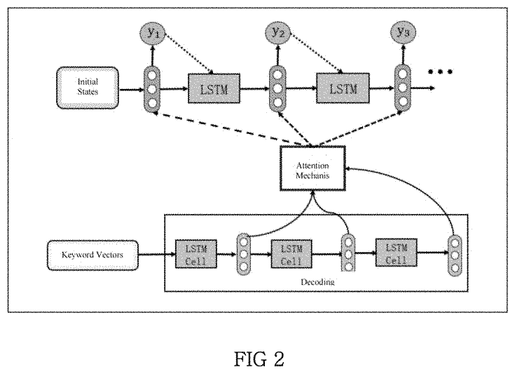

The Encoder-Decoder generation product description text module employs a Senquence to Sequence architecture that is implemented with the codec structure herein, as shown in FIG. 2. The generation process may be seen from the previous description.

The template generation advertisement recommendation text module uses a template-rule generation method, in which a structure of the template, a value range of each variable in the template, and a calling rule of the template need to be defined. When the system operates, the template is called and filled to generate a generated sentence according to the input. The template-based method has certain flexibility and high portability among different task fields. A double-layer template of sentence and phrase are provided in the template-rule generation method, a sentence template is used between sentences, and a phrase template is used within a sentence.

In this embodiment, the sentence template refers to a trustworthy press; and the phrase template refers to a press.

The extracted generation advertisement recommendation text module extracts important information in the text with a textrank extraction method, and synthesizes a corpus of related authors with the textrank, and author-related information obtained from a database with the author name is inputted and an advertisement recommendation text corresponding to keywords about the author is outputted.

In step S7, the product recommendation text is spliced to obtain a final personalized product recommendation text.

What is claimed is:

1. A personalized product description generation method based on multi-source intelligent data, comprising following steps:
step S1: collecting data required for personalized product description, the required data including users and product data respectively used to portrait a user and a product, and reviews for the product used to generate the personalized product description;
step S2: portraiting the product, product attributes most concerned by the user being extracted from the reviews for the product so as to obtain a selling label and corresponding attributes;
step S3: portraiting the user to obtain a user label from historical reviews, and then to obtain a personalized preference label matched with the product portraiting; and
step S4: combining the reviews for the product in step S1 to generate a corresponding personalized product description employing different text generation methods for different preference labels with a codec structure.

2. The method according to claim 1, wherein the portraiting of the user in step S3 employs a quantitative portraiting method, and the historical reviews of the user are statistically analyzed to obtain the user preference label.

3. The method according to claim 1, wherein the method further comprises a redundancy text preprocessing of the reviews for the product in step S4, in which redundant reviews with high similarity are deleted and only representative reviews are reserved for each type of the reviews.

4. The method according to claim 3, wherein the redundancy text preprocessing specifically comprises segmenting the text into words, listing a set of the words corresponding to the sentences (without repeating), calculating a word frequency to obtain word frequency vectors, and then calculating a cosine similarity between word frequency vectors of the sentences according to equation (1):
$$cos ( θ ) = \frac{{\sum }_{i = 1}^{n} ( {x}_{i} * {y}_{i} )}{\sqrt{{\sum }_{i = 1}^{n} {( {x}_{i} )}^{2}} * \sqrt{{\sum }_{i = 1}^{n} {( {y}_{i} )}^{2}}}$$
and removing the word frequency vectors with similarity greater than 0.8 as redundant data.

5. The method according to claim 1, wherein the personalized product description generation in step S4 further comprises word embedding, in which a segmentation operation for words is performed first to divide the sentence into word sequences, segmented data is then word embedded with a Word2vec tool, so as to obtain a vector representation of each word in a sentence sequence.

6. The method according to claim 1, wherein the personalized product description generation method in step S4 comprises a personalized product description generation model containing text generation modules, in which final personalized product recommendation text, namely the product personalized description, is spliced with product recommendation texts obtained with the text generation modules.

7. The method according to claim 6, wherein the personalized product description generation model comprises three text generation modules, an Encoder-Decoder generation product description text module, a template generation advertisement recommendation text module and an extracted generation advertisement recommendation text module.

8. The method according to claim 7, wherein the Encoder-Decoder generation product description text module employs a Senquence to Sequence architecture;
the template generation advertisement recommendation text module uses a template-rule generation method, in which a structure of the template, a value range of each variable in the template, and a calling rule of the template need to be defined, and
according to the input, the template is called and filled to generate a generated sentence; and
the extracted generation advertisement recommendation text module extracts important information in the text with a textrank extraction method, and synthesizes a corpus of related authors with the textrank, and author-related information obtained from a database with the author name is inputted and an advertisement recommendation text corresponding to keywords about the author is outputted.

9. The method according to claim 8, wherein the Encoder-Decoder generation product description text module introduces an Attention mechanism, so that the model may focus on input information that is more important to current target words at every moment of a decoding stage.

10. The method according to claim 8, wherein a double-layer template of sentence and phrase are provided in the template-rule generation method, a sentence template is used between sentences, and a phrase template is used within a sentence.
